(19) United States
(12) Patent Application Publication
(10) Pub. No.: US 2015/0215136 A1
(43) Pub. Date: Jul. 30, 2015

(54) NETWORK CONTROL DEVICE, THE NETWORK CONTROL SYSTEM AND THE METHOD OF THE REMOTE DEVICE

(71) Applicant: SUNIX CO., LTD., New Taipei City 231 (TW)

(72) Inventors: MING-CHENG LIN, NEW TAIPEI CITY 231 (TW); HUNG-CHOU LIN, NEW TAIPEI CITY 231 (TW); CHUN-HUNG LEE, NEW TAIPEI CITY 231 (TW); KAI-TONG JIAN, NEW TAIPEI CITY 231 (TW)

(21) Appl. No.: 14/309,007

(22) Filed: Jun. 19, 2014

(30) Foreign Application Priority Data
Jan. 29, 2014 (TW) 103103384

(51) Int. Cl. H04L 12/66; H04L 29/08; H04L 29/06

(52) U.S. Cl. CPC H04L 12/66; H04L 69/18; H04L 67/125; H04L 69/08

(57) ABSTRACT

A network control device, the network control system and the method of the remote device, the control method comprises of the next steps. A bridge device judges the destination of the packages. If the destination of the package from the second network port is the third network port, the bridge drops the packages. If the destination of the package from the first network port is the third network port, the bridge device merge the operate command according to the packages.

### BACKGROUND OF THE INVENTION

1. Field of the Invention

The instant disclosure relates to a control device, a system and a method thereof; in particular, to a network control device, the network control system and the method of the remote device.

2. Description of Related Art

With the rapid development of Internet, many electronic devices are equipped with remote control functions. For example, an audio and video player could be remote controlled via a network. The unreliable characteristic of the network could be endurable for image transmission or audio transmission, because a small segment loss of the audio and video data is acceptable for the user. However, not all electronic devices are adapted to remote control due to the uncertainty factor existing in the protocol of the network transmission and the environment. In other words, the network packages may be lost during the transmission process. Thus, the remote electronic device may receive incomplete operation command.

In the event of loss packages, the remote electronic device may perform wrong operation or continuous waiting. When the electronic device performs wrong operation, it would cause problem as minor as damaging the machine; or as major as public security accident. Especially for the serial port and the parallel port, these interfaces need complete control command for operation, thus an incomplete control command would make a wrong control to the electronic device having the aforementioned interface, or the electronic device may be damaged.

Further, there exists an issue about “how the main computer be corresponding to the electronic device” for controlling the electronic device via the network. In the prior art, the electronic device is directly connected to the main computer. But, for the network architecture, each host can see the electronic device. Therefore, any host may occupy the use right of the electronic device, such that other hosts may not control the electronic device successfully. Thus, the purpose of hot plugging between the host and the electronic device could not be achieved in the existing network architecture.

### SUMMARY OF THE INVENTION

The object of the instant disclosure is to provide a network control device for providing the main computer to achieve the hot plugging function of one to one correspondence in the network environment.

In order to achieve the aforementioned objects, according to an embodiment of the instant disclosure, a network control device is offered. The network control device comprises a first network port, a second network port a third network port and a processing unit. The first network port is connected to a main computer. The second network port is connected to an electronic device via a network. The third network port is electrically connected to a target device. The processing unit is electrically connected to the first network port, the second network port and the third network port. The processing unit controls the bidirectional transmission between the first network port and the third network port. The processing unit controls the bidirectional transmission between the second network port and the third network port. The processing unit controls the unidirectional transmission from the first network port to the third network port.

In order to achieve the aforementioned objects, according to an embodiment of the instant disclosure, a network control system for a network control device is offered. The network control system comprises an electronic device, a main computer, a target device, a heterogeneous conversion unit and a bridge device. The main computer is for transmitting a first network package having an operation command. The target device is for receiving the operation command or transmitting a response information. The heterogeneous conversion unit is connected to the target device. The heterogeneous conversion unit converts the first network package to the operation command and transmits the operation command to the target device, or the heterogeneous conversion unit converts the response information from the target device to a second network package. The bridge device has a processing unit, a first network port, a second network port and a third network port. The processing unit is connected to the first network port, the second network port and the third network port. The first network port is connected to the main computer. The second network port is connected to the electronic device. The third network port is connected to the heterogeneous conversion unit. The processing unit controls the bidirectional transmission between the first network port and the third network port, and the processing unit controls the unidirectional transmission between the first network port and the third network port.

In order to achieve the aforementioned objects, according to an embodiment of the instant disclosure, a network control method of a remote device is offered. The network control method comprises judging the destination of a network package received by the first network port or the second network port of a bridge device; the bridge device dropping the network packages when the destination of the network packages received by the second network port is a third network port; and the bridge device recombining an operate command according to the network packages when the destination of the network packages received by the first network port is a third network port.

In summary, the provided network control device, the network control system and the method of the remote device could increase the reliability of controlling the serial port device or the parallel port device, thus the remote target device could accurately read the operation command and output the response information. Additionally, the bridge device could achieve the purpose of hot plugging without adding extra hardware cost in the network architecture.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows a schematic diagram of an architecture of the present invention according to an embodiment of the instant disclosure;

FIG. 2A shows a flow chart of the present invention according to an embodiment of the instant disclosure;

FIG. 2B shows an operation scheme of the present invention according to an embodiment of the instant disclosure;

FIG. 3A shows a schematic diagram of packages transmission which is acknowledged according to an embodiment of the instant disclosure;

FIG. 3B shows a schematic diagram of packages transmission which is negative-acknowledged according to an embodiment of the instant disclosure;

FIG. 4 shows a flow chart of a network control method of a remote device according to an embodiment of the instant disclosure;

FIG. 5A shows a schematic diagram of a network package routing of a bridge device according to an embodiment of the instant disclosure;

FIG. 5B shows a schematic diagram of another network package routing of a bridge device according to an embodiment of the instant disclosure;

FIG. 6A shows a schematic diagram of a network package routing of a bridge device according to an embodiment of the instant disclosure;

FIG. 6B shows a schematic diagram of another network package routing of a bridge device according to an embodiment of the instant disclosure; and

FIG. 6C shows a schematic diagram of another bridge structure according to an embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

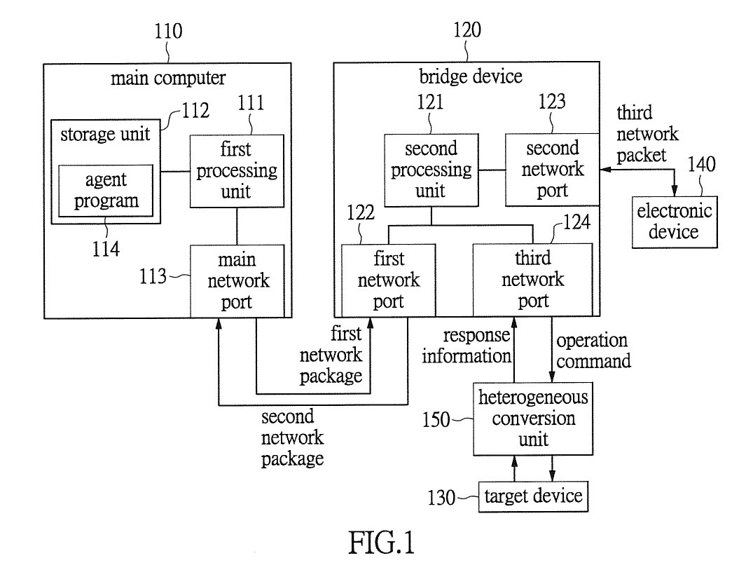

Please refer to FIG. 1 showing a schematic diagram of an architecture of the present invention according to an embodiment of the instant disclosure. The network control system comprises a main computer 110, a bridge device 120, a target device 130, an electronic device 140 and a heterogeneous conversion unit 150. The main computer 110 is connected to the bridge device 120 via a network. The network in the present invention may be Internet or Intranet. For ease of explanation, the Intranet is used in the embodiments; however an artisan of ordinary skill in the art will appreciate to apply the technique to the environment of Internet. The heterogeneous conversion unit 150 is connected to the bridge device 120 and the target device 130.

The main computer 110 has a first processing unit 111, a storage unit 112 and a main network port 113. The first processing unit 111 is electrically connected to the storage unit 112 and the main network port 113. The main computer 110 of the present invention makes a general reference to a calculator having network connectivity. The main network port 113 could be embodied by wire-connection manner or wireless-connection manner. The mentioned calculator may be but not restricted to a personal computer (PC), a notebook or a tablet PC . . . etc.

The main computer 110 transmits the operation command to the bridge device 120 or receives output information from the bridge 120 via the main network port 113. The type of the main network 113 may be but not restricted to a wired Ethernet, or a wireless network. The storage unit 112 stores an agent program 114. The first processing unit 111 executes the agent program 114. The agent program not only is for searching the bridge device 120, transmitting the operation command or receiving the response information, but also is for the process of dividing the aforementioned operation command in the a plurality of network packages. The agent program 114 may be an independent application, or built in the operation system. The first processing unit 111 deploys the agent program 114 according to the identification information transmitted from the bridge device 120 for setting up an address space and a plurality of connection channels.

Referring to FIG. 1, the bridge device 120 has a second processing unit 121, a first network port 122, a second network port 123 and a third network port 124. The second processing unit 121 is connected to the first network port 122, the second network port 123 and the third network port 124. The second processing 121 is for recombining the received network packages, converting the returned response information of the target device 130 to the network packages, or judging the destination of the network package to determine to retain or drop the network package which would be described thereafter. The first network port 122 of the bridge device 120 is connected to the main network port 113 of the main computer 110 via the network. The bridge device 120 transmits a classification information to the main computer 110 via the first network port 122. The second network port 123 of the bridge device 120 is connected to the electronic device 140.

The classification information records the model of the bridge device 120. The third network port 124 is connected to the heterogeneous conversion unit 150. The heterogeneous conversion unit 150 can be externally connected to the bridge device 120 via the network port. Alternatively, both of the heterogeneous conversion unit 150 and the bridge device 120 can be integrated into a chipset. The heterogeneous conversion unit 150 is for recombining the network packages to output the operation command or dividing the response information to corresponding network packages. The target device 130 is electrically connected to the heterogeneous conversion unit 150. The type of the target device 130 may be an electronic device having the parallel port, the serial port, the digital I/O or the Universal Asynchronous Receiver/Transmitter. The target device 130 may be a RS-232 mouse, a digital I/O bar coder reader . . . etc.

In the present invention, the network packages transmitted from the main computer 110 to the bridge device 120 are defined as the first network packages. The network packages transmitted from the bridge device 120 to the main computer 110 are defined as the second network packages. The network packages transmitted between the bridge device 120 and the target device 140 are defined as the third network packages.

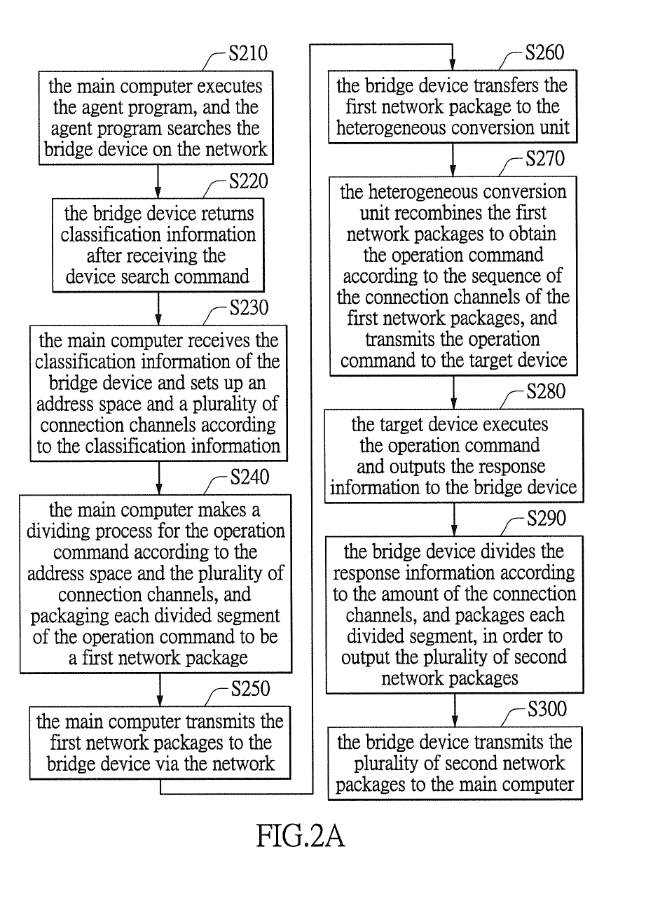

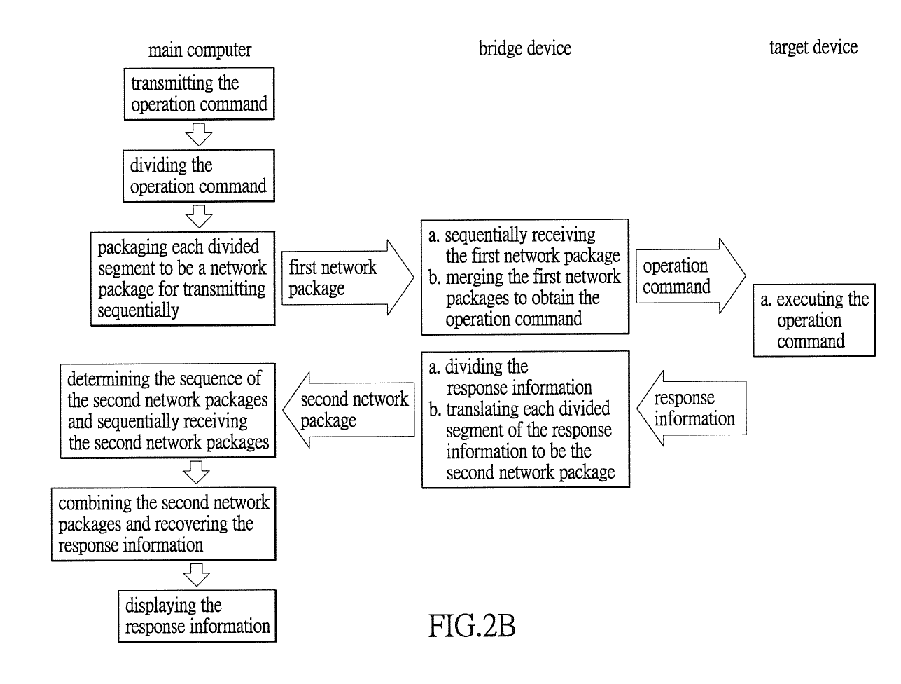

Please refer to FIG. 2A for further understanding the control of the target device. The control and transmitting method of the present invention comprises following steps:

S210: the main computer executes the agent program, and the agent program searches the bridge device in the network;

S220: the bridge device returns the classification information after receiving the device search command;

S230: the main computer receives the classification information of the bridge device and sets up an address space and a plurality of connection channels according to the classification information;

S240: the main computer makes a dividing process for the operation command according to the address space and the plurality of connection channels, and packaging each divided segment of the operation command to be a first network package;

S250: the main computer transmits the first network packages to the bridge device via the network;

S260: the bridge device transfers the first network package to the heterogeneous conversion unit;

S270: the heterogeneous conversion unit recombines the first network packages to obtain the operation command according to the sequence of the connection channels of the first network packages, and transmits the operation command to the target device;

S280: the target device executes the operation command and outputs the response information to the bridge device;

S290: the bridge device divides the response information according to the amount of the connection channels, and packages each divided segment, in order to output the plurality of second network packages; and

S300: the bridge device transmits the plurality of second network packages to the main computer.

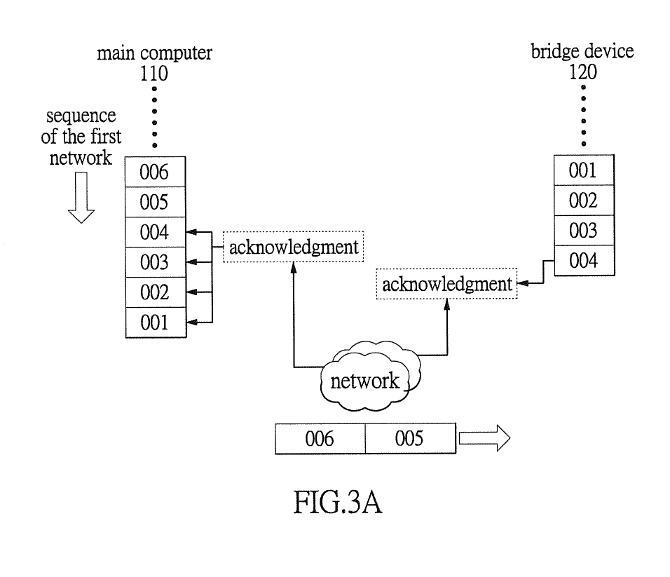

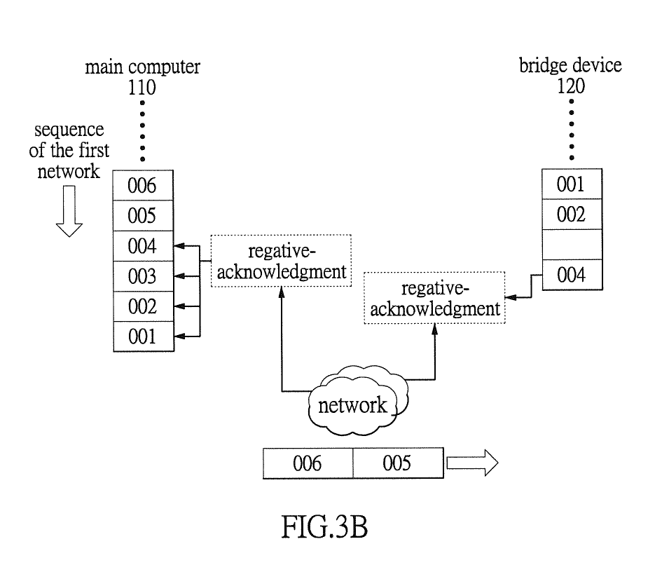

In order to explain the whole operation, please refer to FIG. 2B in conjunction with FIG. 3A and FIG. 3B. Firstly, the main computer 110 starts to execute the agent program 114. The agent program 114 searches the bridge device 120 on the network. When the bridge device 120 receives the equipment search command, the bridge device 120 returns the corresponding classification information. The identify information records the type and the amount of the ports of the bridge device 120, the model of the target device 130 or the bridge device 120.

When the main computer 110 receives the classification information, the main computer could generate the address space and the plurality of connection channels according to the classification information. The size of the address space is determined by the type of the target device 130. The amount of the connection channels may be determined according to the target device 130 or be default as a constant amount. Because the target device 130 is connected to the main computer 110 via the network, the main computer 110 needs to generate the corresponding address space for the purpose of address access of the main computer 110.

When the main computer 110 transmits the operation command (or related processing data) to the target device 130, the agent program 114 would make a dividing process for the operation command. In this present invention, the agent program 114 divides the operation command into a plurality segments according to the amount of the connection channels. Thus, the agent program 114 would output the divided segments with the amount the same as to the amount of the connection channels. The agent program 114 obtains an offset corresponding to each divided segment of the operation command.

For ease of explanation for the divided operation command (or operation data), each divided part of the operation command is defined as a divided segment. The agent program 114 converts the divided segments and the corresponding offsets to the first network packages in sequence according to the connection channels, and transmits the first network packages to the bridge devices 120.

After the bridge device 120 receiving the first network packages, the bridge device 120 transfers the first network packages to the heterogeneous conversion unit 150. The heterogeneous conversion unit 150 determines whether the sequence of the received first network packages is correct according to the sequence of the offset recorded by the connection channels. Please refer to FIG. 3A in conjunction with FIG. 3B both showing the receiving sequences of the first network packages. The left portions of the FIG. 3A and FIG. 3B show the transmitting sequences of the first network packages made by the main computer 110, and the right portions show the receiving sequence of the network packages for the heterogeneous conversion unit 150.

The heterogeneous conversion unit 150 determines whether the amount of the continuously received first network packages is larger than a preset amount. If the amount of the continuously received first network packages is larger than the present amount, the heterogeneous conversion unit 150 would return an acknowledgment (ACK) to the main computer 110. When the main computer 110 receives the acknowledgment, the main computer 110 would transmit the rest first network packages to the heterogeneous conversion unit 150. For example, the main computer 110 serially transmits the first network packages 001, 002, 003 and 004 to the heterogeneous conversion unit 150. If the heterogeneous conversion unit 150 serially receives the first network packages 001, 002, 003 and 004, the heterogeneous conversion unit 150 will transmit the acknowledge to the main computer 110 and request the main computer 110 to further transmit subsequent first network packages 005, 006. Then, the heterogeneous conversion unit 150 would counts from the first network package 005 to determine whether the amount of the continuously received first network packages is larger than the preset amount.

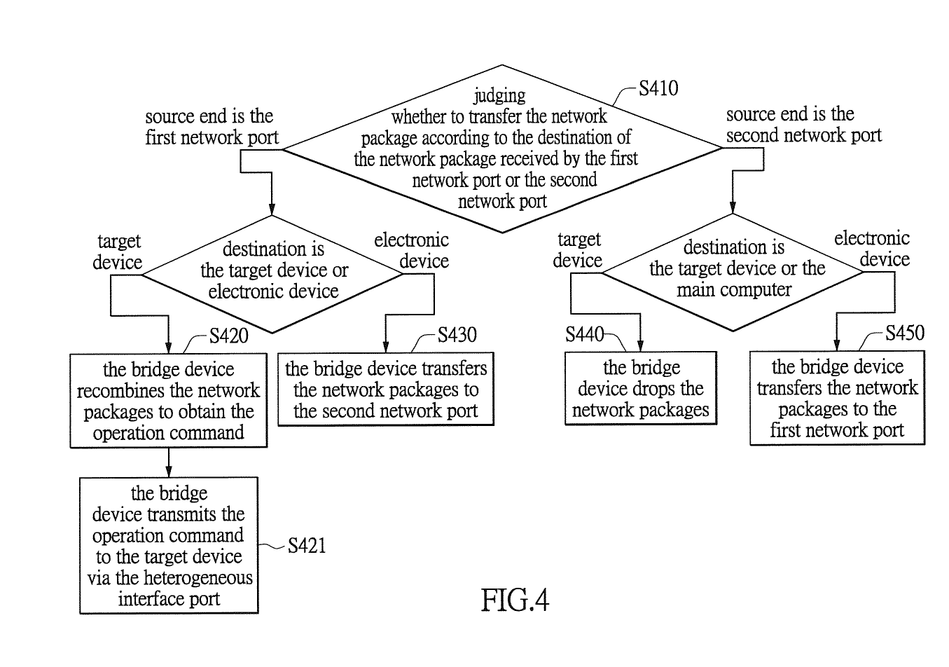

When the sequence of the first network packages received by the heterogeneous conversion unit 150 is not continuous, the bridge device 120 would request the main computer 110 to re-transmit the lost first network package(s). As shown in FIG. 4, the bridge device 120 does not receive the first network package 003, but the bridge device 120 receives the first network package 004 in previous. Then, the bridge device 120 would transmit a negative-acknowledgment (NAK) of the first network package 003. And, the bridge device 120 stops receiving the first network packages after the first network package 003. That is, the heterogeneous conversion unit 150 would drop the first network package 004 (and the subsequent first network packages 005, 006) and heterogeneous conversion unit 150 would wait for the first network package 003.

When the main computer 110 receives the negative-acknowledgment, the main computer 110 would stop transmitting the current transmitting first network packages, and re-transmit the first network package 003 which was not received by the heterogeneous conversion unit 150. As shown in FIG. 3B, the heterogeneous conversion unit 150 does not receives the first network package 003, and thus starting from the first network package 003 the main computer 110 would re-transmit the rest sequent first network packages 004, 005, 006.

Then, the heterogeneous conversion unit 150 recombines the received first network packages, in order to obtain the operation command for the target device 130. The bridge device 120 transmits the operation command to the target device 130 via the third network port 124. The target device 130 executes corresponding operation according to the operation command. After the target device 130 completes the operation, the target device 130 may output the corresponding result. Meanwhile, the target device 130 would output the operation result to the heterogeneous conversion unit 150.

The heterogeneous conversion unit 150 executes the dividing process for the operation result according to the amount of the connection channels in the same way. The heterogeneous conversion unit 150 transforms each divided segment to the second network package, and transmits the second network packages to the main computer 110. The transmission and processing manners for the second network packages are the same as that for the first network packages, thus the redundant information is not repeated. When the main computer 110 receives the second network packages, the main computer 110 recombines the second network packages to obtain the operation result of the target device 130.

Besides the aforementioned processing of controlling the remote target device 130, this invention also provides following routing processing method for giving a solution to one to one correspondence controlling process of the main computer 110 and the target device 130. Please refer to FIG. 4 showing a flow chart of a network control method of a remote device according to an embodiment of the instant disclosure. The network control method of the remote device comprises following steps:

S410: judging the destination of the network package received by the first network port or the second network port;

S420: the bridge device recombines the network packages to obtain the operation command when the destination of the first network package received by the first network port is the third network port;

S421: the bridge device transmits the operation command to the target device via the third network port;

S430: the bridge device transfers the network packages to the second network port when the destination of the first network package received by the first network port is the electronic device;

S440: the bridge device drops the network packages when the destination of the third network package received by the second network port is the third network port; and

S450: the bridge device transfers the network packages to the first network port when the destination of the third network package received by the second network port is the main computer.

The bridge device 120 judges the destination of the received network package. The mentioned destination of the present invention is the receiving object of the network package. For example, the electronic device 140 is the destination of the network package when the main computer 110 transmits the network package to the electronic device 140.

Firstly, the main computer 110 is taken as the source end for explanation, and the following description taking another bridge device as the electronic device for explaining clearly. The main computer 110 is connected to the bridge device A via the main network port, the bridge device A is connected to the bridge device B and the target device α, and the bridge device B is connected to the target device β.

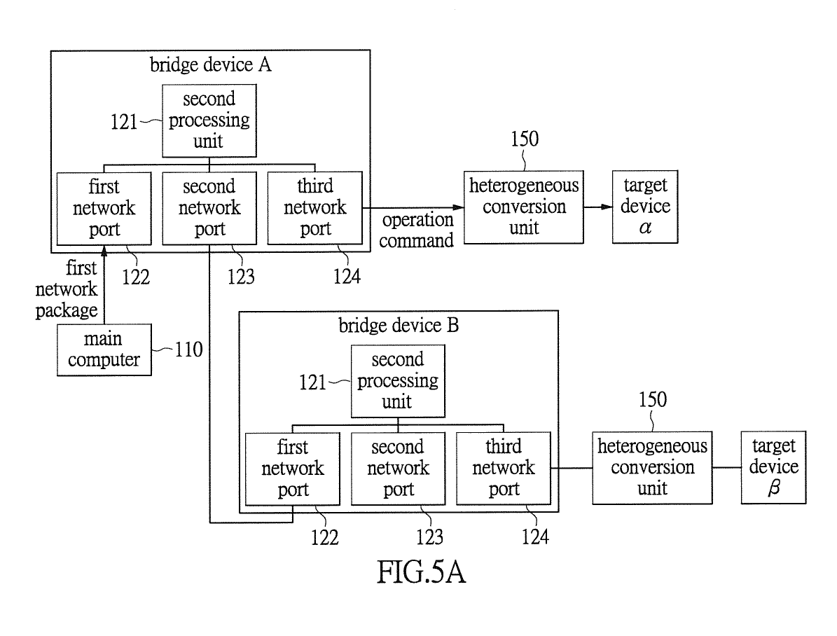

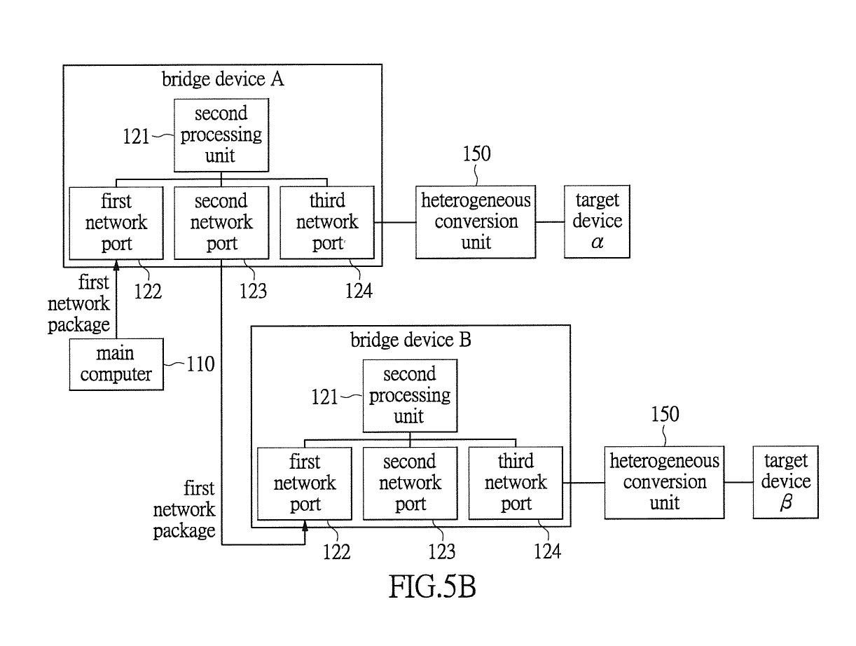

Please refer to FIG. 5A in conjunction with FIG. 5B, when the bridge device A receives the first network packages from the main computer 110, the bridge device A judges whether the first packages are for the operation command of the target device a. When the first network packages are the operation command, the bridge device A recombines the first network packages to output the operation command, as shown in FIG. 5A. Then, the bridge device A transmits the operation command to the target device α.

When the destination of the first network package is the bridge device B, the bridge device A transmits the first network package to the bridge device B. And, the bridge device A does not make any other process about the first network package, as shown in FIG. 5B. The aforementioned classification information could be used to identify the type of the bridge device, thus the main computer could add the network package with the information which assigning the target device of what bridge device to execute the operation.

When the main computer 110 intends to control the target device β of the bridge device B, the bridge device A would transfer the first network packages to the bridge device B after receiving the network package from the main computer 110. Then, the bridge device B would start to combine the network packages after receiving the network packages, in order to obtain the corresponding operation command.

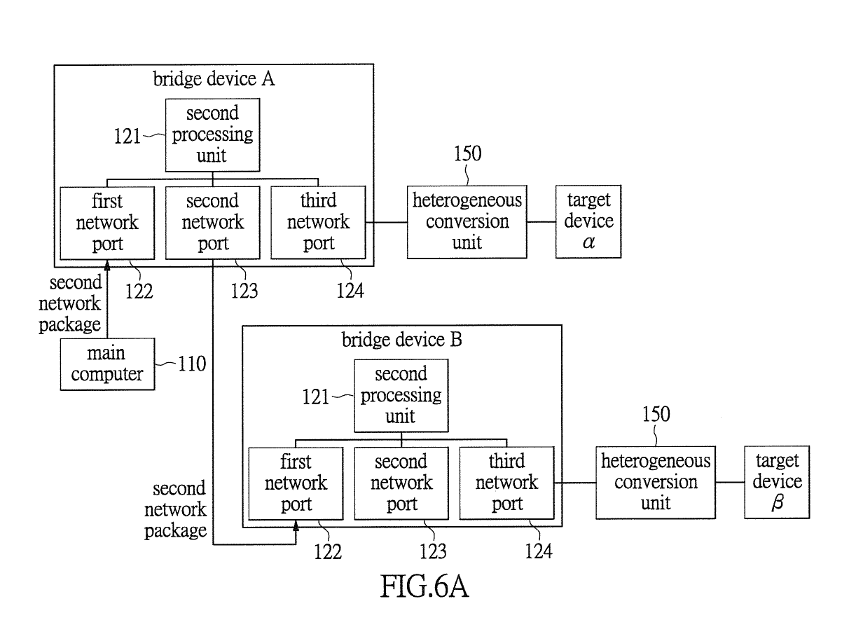

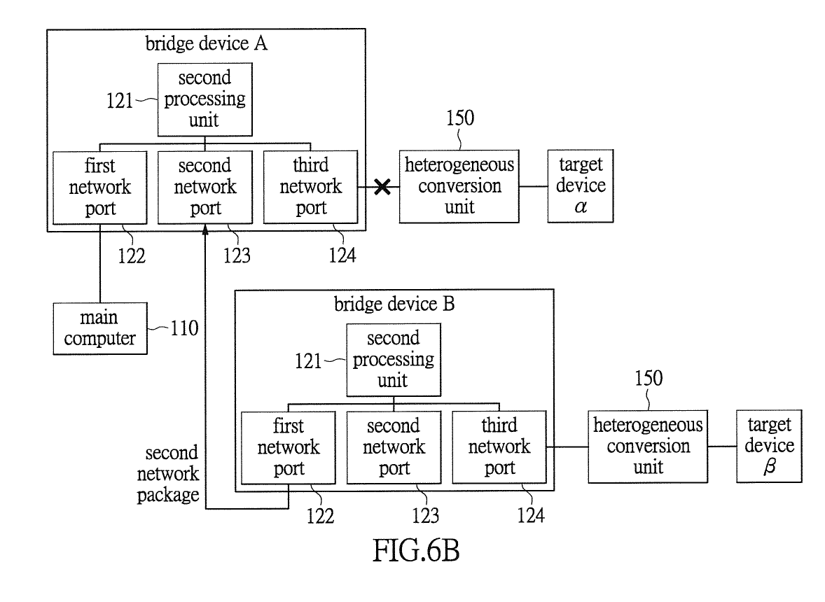

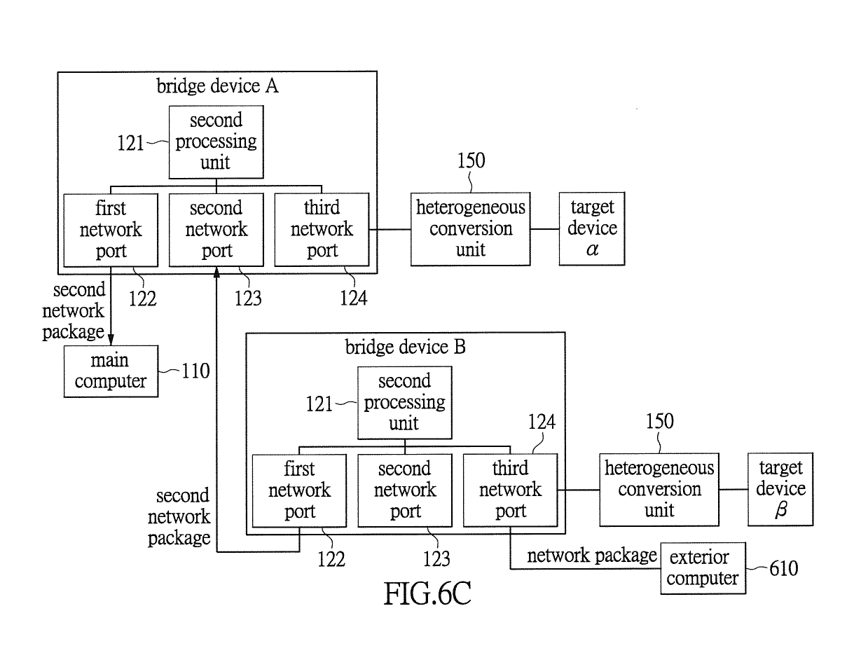

Then, when the bridge device A receives the third network packages from the second network port, the bridge device A would judge whether the destination of the third network package is the main computer 110. Please refer to FIG. 6A in conjunction with FIG. 6B, respectively showing the network package routing of the bridge device. When the destination of the third network package is the main computer 110, the bridge device A does not make further process to the third network package, as shown in FIG. 6A, but transfers the third network package to the main computer 110. When the destination of the third network package is the target device, the bridge device A drops the network package, as shown in FIG. 6B.

When the second network port of the bridge device B is connected to another computer (which is defined as an exterior computer), as shown in FIG. 6C, the exterior computer could transmit network packages to the main computer via the bridge device A and the bridge device B. Because the bridge device A (or the bridge device B) could judge the destination of the network package, the bridge device A (or the bridge device B) could block the network package for the target device transmitted from the exterior computer. And, the main computer 110 still could communication with the exterior computer. As a result, the correspondence relation between the main computer 110 and each target device could be ensured. In other words, the processing unit 121 of the bridge device 120 controls the bidirectional transmission of the network packages between the first network port 122 and the third network port 124. The processing unit 121 controls the bidirectional transmission of the network packages between the second network port 123 and the third network port 124. The processing unit 121 controls the unidirectional transmission of the network packages from the first network port 122 to the third network port 124.

According to above descriptions, the network control system, the bridge device and the method of the remote device could increase the reliability of controlling the serial port device or the parallel port device, thus the remote target device 130 could accurately read the operation command and output the response information. Additionally, the bridge device could achieve the purpose of hot plugging without adding extra hardware cost in the network architecture.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A network control device, comprising:
a first network port, connected to a main computer;
a second network port, connected to an electronic device via a network;
a third network port, electrically connected to a target device; and
a processing unit, electrically connected to the first network port, the second network port and the third network port, the processing unit controlling the bidirectional transmission between the first network port and the third network port, the processing unit controlling the bidirectional transmission between the second network port and the third network port, and the processing unit controlling the unidirectional transmission from the first network port to the third network port.

2. The network control device according to claim 1, further comprising a heterogeneous conversion unit connected between the third network port and the target device.

3. The network control device according to claim 2, wherein the processing unit transfers a first network package from the main computer to the heterogeneous conversion unit, the heterogeneous conversion unit recombines the first network packages to output an operation command, the heterogeneous conversion unit transmits the operation command to the target device, the heterogeneous conversion unit transmits a response information from the target device to the processing unit, the processing unit converts the response information to a second network package and transmits the second network package to the main computer.

4. A network control system for a network control device, the network control system comprising:
an electronic device;
a main computer, for transmitting a first network package having an operation command;
a target device, for receiving the operation command or transmitting a response information;
a heterogeneous conversion unit, connected to the target device, the heterogeneous conversion unit converting the first network package to the operation command and transmitting the operation command to the target device, or the heterogeneous conversion unit converting the response information from the target device to a second network package; and
a bridge device, having a processing unit, a first network port, a second network port and a third network port, the processing unit connected to the first network port, the second network port and the third network port, the first network port connected to the main computer, the second network port connected to the electronic device, the third network port connected to the heterogeneous conversion unit, the processing unit controlling the bidirectional transmission between the first network port and the third network port, and the processing unit controlling the unidirectional transmission between the first network port and the third network port.

5. The network control system according to claim 4, wherein the processing unit transfers the first network package from the main computer to the heterogeneous conversion unit, the heterogeneous conversion unit recombines the first network packages to output the operation command, the heterogeneous conversion unit transmits the operation command to the target device, the heterogeneous conversion unit transmits the response information from the target device to the processing unit, the processing unit converts the response information to the second network package and transmits the second network package to the main computer.

6. A network control method of a remote device, comprising:
judging the destination of a network package received by a first network port or a second network port of a bridge device;
the bridge device dropping the network packages when the destination of the network packages received by the second network port is a third network port; and
the bridge device recombining an operate command according to the network packages when the destination of the network packages received by the first network port is a third network port.

7. The network control method of the remote device according to claim 6, wherein the step of judging the destination of the network package further comprising:
the bridge device transmitting the operation command to a target device via the third network port;
the bridge device transferring the network packages received by the first network port to the second network port when the destination of the network package received by the first network package is the second network port; and
the bridge device transferring the network packages received by the second network port to the first network port when the destination of the network packages received by the second network port is the main computer.

8. The network control method of the remote device according to claim 6, wherein when the third network port transmits a response information to the bridge device, the bridge device converts the response information to the network package and transmits the network package to the main computer.
